(19) United States
(12) Patent Application Publication
(10) Pub. No.: US 2007/0134628 A1
(43) Pub. Date: Jun. 14, 2007

(54) Bilingual safety manual

(76) Inventor: Lawrence D. Capello, Fort Myers, FL (US)

Correspondence Address: FRASER CLEMENS MARTIN & MILLER LLC, 28366 KENSINGTON LANE, PERRYSBURG, OH, 43551, US

(21) Appl. No.: 11/606,485

(22) Filed: Nov. 30, 2006

Related U.S. Application Data
(60) Provisional application No. 60/748,657, filed on Dec. 8, 2005.

(51) Int. Cl. G09B 19/00

(52) U.S. Cl. 434/156

(57) ABSTRACT

A bilingual handbook having illustrated embodiment of a message to be conveyed with a supporting description in one language on one side of a page and the same illustration and description in a second language appearing on a side of an adjacent page for use in teaching certain principles to persons with another language different from the teacher.

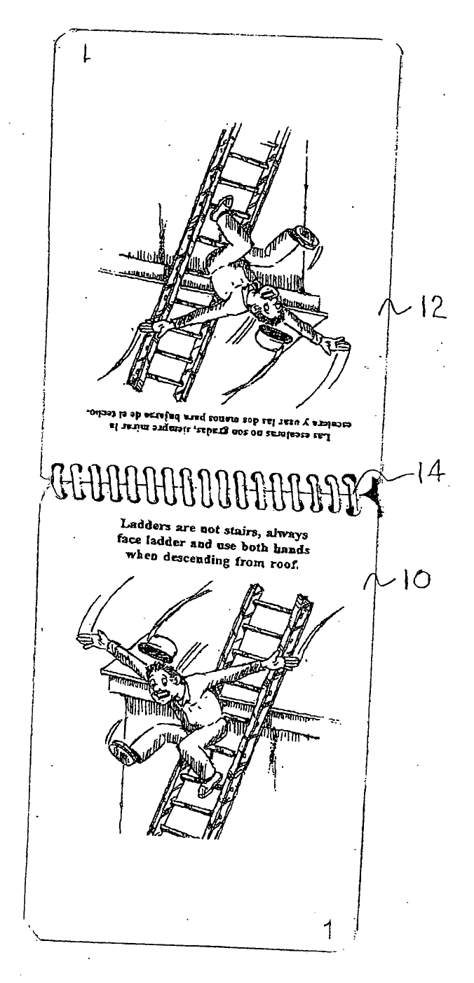

### CROSS-REFERENCE TO RELATED APPLICATION

This application claims the benefit of provisional patent application Ser. No. 60/748,657 filed on Dec. 8, 2005.

### BACKGROUND OF THE INVENTION

In the last decade, the Hispanic population of the United States has grown almost 60%, increasing the need to properly communicate to both English and Spanish-speaking workers. In order to reduce the chances for injuries or deaths in the workplace by effectively communicating with workers concerning the important safety issues, it becomes increasingly important to convert English messages into effective bilingual wordings and illustrations.

It has been found that merely translating a typical English language safety manual into another language has not been completely effective in conveying the necessary messages.

Safety for the workers is of paramount importance for many obvious reasons. However, in addition to the objective of reducing jobsite injuries, it must be understood that safety results in a direct advantage to the employer by way of increased profits, resulting in pay increases, higher budgets with the ability to purchase training aids and personal protective equipment for the workers.

Ideally, the person who leads the safety orientation of a company should be bilingual, but in many situations bilingually trained individuals are not available, but nevertheless, the safety orientation must be transmitted to the employees.

It is known that illustrations are extremely helpful in demonstrating certain safety principles. However, to be most effective, there must be supplemental explanation to properly convey the message.

### SUMMARY OF THE INVENTION

It has surprisingly been discovered that the above objectives, as well as others, may be achieved by a handbook comprised of a plurality of pages, each page having a first side and a second side, the first side of the pages containing an illustration and explanatory information written in one language and the second side of the pages containing an illustration different from the first side with explanatory information written in a second language; and a binding containing at least one edge of the pages so that the second side of the pages is in face-to-face relation with the first side of each adjacent page with sides containing like illustrations to be in face-to-face relation when the pages of the handbook are closed.

### BRIEF DESCRIPTION OF THE DRAWINGS

The above objects and advantages of the invention will become readily manifest to those skilled in the art from reading the following description of a preferred embodiment of the invention when considered in the light of the accompanying drawing.

### DESCRIPTION OF THE PREFERRED EMBODIMENT OF THE INVENTION

The foreign language speaking population in the United States has grown very substantially. To facilitate the assimilation of these persons into the workplace and to comply with the many Federal safety regulations imposed upon employers, it has become mandatory for the employers to adopt a unique, simple, and understandable method and means for adequately communicating these regulations to the members of the workplace who did not have English as their first language. While bilingual safety manuals have been used in this regard in many of the trades for sometime, it has still determined that a more comprehensive program was necessary. Accordingly, history manifests that illustrated examples of the major safety principles to be conveyed was helpful. However, even more comprehensive means were deemed critical due to the occurrence of activities thought to be conveyed were, in face, causing accidents even though the causation has been covered in the previous bilingual manuals.

It has been discovered that excellent results may be realized by formatting a handbook comprised of pages each typically containing an illustrated embodiment of a principle or message with a subtitle or explanation written in English on one side of a page, and the opposite side containing a different illustration and appropriate explanation written in a different language and then compiling the pages in a manner such that the same caricature is present on the facing side of the adjacent page with the same message, one written in English and the other in Spanish. The handbook is comprised of a number of separate pages as indicated on the accompanying drawing by reference numerals 10 and 12. Each of the pages 10 and 12 contain two separate drawings or illustrations and supporting explanatory written material, one written in English and the other in another language such as Spanish, for example.

The entire safety manual is comprised of a compilation of the pages with illustrations and accompanying messages appearing in the same manner as illustrated in the accompanying drawing.

In a preferred embodiment of the invention, a helical binding 14 is caused to be received in suitably formed holes formed in the similarly configured upper edges of the compiled pages containing the illustrations and appropriate bilingual messages. While the preferred embodiment of the invention utilizes a helical bonding, it will be appreciated that other types of bindings which enable a similar disposition of adjacent pages on associated manual to be brought about.

In use, typically the safety director of a company will conduct a safety seminar with the workers. During the seminars, the various activities and conditions are explained orally. So long as both the director and the employees communicate in the same language all is well. However, in instances when the employees' mother language is different from that of the safety director, the line of communication may utterly fail.

Surprisingly good results have been achieved in bridging the communication gap by the utilization of a handbook or manual embodying the present invention by the safety director and the workers. The handbook is most effectively used in a one-to-one tutorial relation to assist in overcoming the language barrier by simply from illustrations and wording in at least two languages simultaneously. The handbook is typically opened by flipping the first illustration sheets to a position in which the English language illustration faces the safety director and the illustrations in the language of the worker faces the worker. The described position of pages of the handbook permits a safety director to adequately explain the particular act or condition to the worker.

It will be appreciated that the invention helps to keep workers safety conscious, motivates workers to work safely; causes both management and labor to become active in safety programs; and above all helps to prevent accidents.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A bilingual handbook comprising:
a plurality of separate pages, each page having a first side and a second side, the first side of the pages containing an illustration and explanatory information written in one language, and the second side of the pages containing an illustration different from the first side with explanatory information written in a second language; and
a binding containing at least one edge of the pages so that the second side of each of the pages is in face-to-face relation with the first side of each adjacent page permitting the sides containing like illustrations to be in face-to-face relation when the pages of the handbook are closed.

2. A bilingual handbook as described in claim 1 wherein each of the pages include at least one similarly configured edge.

3. A bilingual handbook as described in claim 2 wherein the binding extends along the similarly configured edges.

4. A bilingual handbook as described in claim 3 wherein the binding includes a helically wound member.

5. A bilingual handbook as described in claim 1 wherein the binding includes fasteners.

6. A bilingual handbook as described in claim 5 wherein the fasteners are spaced apart.

7. A method of producing a bilingual handbook consisting of a number of separate pages each of which contains an illustration with supporting explanatory material in respect of a certain message to be conveyed in one language on one side and another different illustration with supporting explanatory written material in respect of another message to be conveyed in a second language on the opposite side, including the steps of assembling the separate pages in a compilation such that the pages are arranged to have illustrations and supporting explanatory material in one language on one side thereof and illustrations and supporting explanatory material relating to another message in a second language on the opposite side thereof; and binding the pages together in a manner to permit like illustrations and corresponding different languages to be in face-to-face relation when the handbook is closed and to be viewed simultaneously from opposite sides when opened.
